(19) United States
(12) Patent Application Publication
(10) Pub. No.: US 2010/0144354 A1
(43) Pub. Date: Jun. 10, 2010

(54) HOST APPARATUS, MOBILE STATION, SERVING BASE STATION, TARGET BASE STATION, AND COMMUNICATION METHOD THEREOF FOR USE IN A WIRELESS NETWORK

(75) Inventors: Chih-Hsiang HO, Taipei (TW); Heng-Iang HSU, Taipei (TW); Ching-Lun LIN, Zhongli City (TW)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 12/369,480

(22) Filed: Feb. 11, 2009

(30) Foreign Application Priority Data
Dec. 10, 2008 (TW) 097148034

(51) Int. Cl. H04W 36/00; H04W 4/00

(52) U.S. Cl. 455/437; 370/331

(57) ABSTRACT

A host apparatus, a mobile station, a serving base station, a target base station, and a communication method thereof for use in a wireless network are provided. The wireless network comprises at least one mobile station, the host apparatus, a serving base station, and a target base station. The at least one mobile station and the host apparatus belongs to a same handover group, and receive a handover request signal from the serving base station. The host apparatus transmits a handover confirmation signal to the serving base station so that the at least one mobile station and the host device of the handover group handover to the target base station. Thereby, the at least one mobile station can be handed over to the target base station without need to transmit the handover confirmation signal, so as to save the bandwidth of the wireless network.

This application claims priority to Taiwan Patent Application No. 097148034 filed on Dec. 10, 2008.

### CROSS-REFERENCES TO RELATED APPLICATIONS

Not applicable.

### BACKGROUND OF THE INVENTION

1. Field of the Invention

The present invention relates to a host apparatus, a mobile station, a serving base station, a target base station, and a communication method thereof for use in a wireless network. More specifically, the present invention relates to a host apparatus, a mobile station, a serving base station, a target base station, and a communication method thereof for use in a wireless network with a handover function.

2. Descriptions of the Related Art

With the continuous advancement in science and technology, ever higher requirements for the people are being imposed on communications. Nowadays, more and more importance is being attached to convenience of communications in addition to requirements on quality of communications. Among the various communication means, the wireless communications are advantageous in that they provide higher mobility by obviating the need of physical communication network wiring. Therefore, the mobile products with wireless-communication function (i.e., mobile stations), such as mobile phones, notebooks, and so on, are gaining more and more popularity in recent years and have become the mainstream products in the consumer electronics market.

However, in practice, the mobile stations often have to handover between the different base stations according to the environments in order to maintain a certain quality of service (QoS). Therefore, the handover procedures occur very frequently in some specific environments, for example, on trains, buses, subways, high-speed rails, and etc. More specifically, FIG. 1 is a schematic view of a wireless network 1. The wireless network 1 comprises the base stations 11, 13 and mobile stations 15, 17, 19. The base station 11 has a coverage 110, and the base station 13 has a coverage 130. Users of the mobile stations 15, 17, 19 are on a bus 2.

As can be seen in FIG. 1, the mobile stations 15, 17, 19 are all on the bus 2; in other words, the mobile stations 15, 17, 19 may all be considered to be in the same environment. From viewpoints of the mobile stations 15, 17, 19, the bus 2 is traveling from the coverage 110 of the base station 11 to the coverage 130 of the base station 13, the signal strength of the base station 11 will fade away while that of the base station 13 will become stronger gradually. To ensure a certain quality of service, it is highly probable that the mobile stations 15, 17, 19 will handover from the base station 11 to the base station 13 within the same time period. In this case, the mobile stations 15, 17, 19 have to perform a handover procedure with the base station 13 respectively, which places a heavy burden on the base stations 11, 13 because this necessitates processing of the massive handover-related control messages by the base stations 11, 13 within the handover time period. Moreover, the communications of the handover-related control messages between the base stations 11, 13 and the mobile stations 15, 17, 19 also waste a great bandwidth of the wireless network 1.

Accordingly, an urgent need exists in the art to effectively decrease the burden of the base stations and the wireless network in processing the handover-related control messages during a mobile station's handover procedure, thereby to increase the handover efficiency and the overall effectiveness of the wireless network as a whole.

### SUMMARY OF THE INVENTION

One objective of the present invention is to provide a host apparatus for use in a wireless network. The wireless network comprises at least one mobile station, a serving base station, and a target base station. The at least one mobile station and the host apparatus belong to a same handover group and each of them communicates via the serving base station respectively. The host apparatus comprises a reception module and a transmission module. The reception module is configured to receive information, relating to the target base station, from the serving base station, and receive a group handover request signal, which is transmitted in a multicast way, from the serving base station The transmission module is configured to transmit a handover confirmation signal to the serving base station according to the group handover request signal and the information so that the at least one mobile station and the host apparatus of the handover group handover to the target base station.

Another objective of the present invention provides a communication method for a host apparatus. The host apparatus is used in a wireless network. The wireless network comprises at least one mobile station, a serving base station, and a target base station. The at least one mobile station and the host apparatus belong to a same handover group and each of them communicates via the serving base station respectively. The communication method comprises the steps of: receiving information, relating to the target base station, from the serving base station; receiving a group handover request signal, that is transmitted in a multicast way, from the serving base station; transmitting a handover confirmation signal to the serving base station according to the group handover request signal and the information so that the at least one mobile station and the host apparatus of the handover group handover to the target base station.

A further objective of the present invention provides a mobile station for use in a wireless network. The wireless network comprises a host apparatus, a serving base station, and a target base station. Each of the mobile station and the host apparatus communicates via the serving base station respectively. The mobile station comprises a reception/transmission module and a process module. The reception/transmission module is configured to transmit a group joining signal to the host apparatus so that the host apparatus joins the mobile station and the host apparatus join to a handover group according to the group joining signal. In addition, the reception/transmission module is configured to receive information, relating to the target base station, from the serving base station, and a group handover request signal, that is transmitted in a multicast way, from the serving base station. The process module is configured to process is configured to handover to the target base station according to the group handover request signal and the information.

Yet another objective of the present invention provides a communication method for use in a mobile station. The mobile station is used in a wireless network. The wireless network comprises a host apparatus, a serving base station, and a target base station. Each of the host apparatus and the mobile station communicates via the serving base station respectively. The communication method comprises the steps of: transmitting a group joining signal to the host apparatus so that the host apparatus joins the mobile station and the host apparatus to a handover group according to the group joining signal; receiving information, relating to the target base station, from the serving base station; receiving a group handover request signal, that is transmitted in a multicast way, from the serving base station; and handovering to the target base station according to the group handover request signal and the information.

Still another objective of the present invention provides a serving base station for use in a wireless network. The wireless network comprises at least one mobile station, a host apparatus, and a target base station. The host apparatus and the at least one mobile station belong to a same handover group and each of them communicates via the serving base station respectively. The serving base station comprises a transmission module and a reception module. The transmission module is configured to transmit information, relating to the target base station, in a broadcast way and transmit a group handover request signal to the at least one mobile station and the host apparatus in a multicast way, so as to request the at least one mobile station and the host apparatus to handover to the target base station and make the host apparatus transmit a handover confirmation signal according to the information and the group handover request signal. The reception module is configured to receive the handover confirmation signal to handover the host apparatus and the at least one mobile station of the handover group to the target base station.

Yet a further objective of the present invention provides a communication method for use in a serving base station. The serving base station is used in a wireless network. The wireless network comprises at least one mobile station, a host apparatus, and a target base station. The host apparatus and the at least one mobile station belong to a same handover group and each of them communicates via the serving base station respectively. The communication method comprises the steps of: transmitting information, relating to the target base station, in a broadcast way; transmitting a group handover request signal to the at least one mobile station and the host apparatus in a multicast way, so as to request the at least one mobile station and the host apparatus to handover to the base station and make the host apparatus transmit a handover confirmation signal according to the information and the group handover request signal; receiving the handover confirmation signal to handover the host apparatus and the at least one mobile station of the handover group to the target base station.

Still a further objective of the present invention provides a target base station for use in a wireless network. The wireless network comprises at least one mobile station, a host apparatus, and a serving base station. The host apparatus and the at least one mobile station belong to a same handover group and each of them communicates via the serving base station respectively. The serving base station comprises a reception/transmission module. The reception module is configured to transmit uplink information to the host apparatus after the host apparatus and the at least one mobile station of the handover group handover to the target base station, so that the host apparatus processes a handover network entry with optimization procedure with the target base station according to the uplink information. The reception/transmission module is further configured to transmit a handover completion signal in a multicast way to inform the host apparatus and the at least one mobile station of the handover group that handovering to the target base station is completed.

Yet a further objective of the present invention provides a communication method for use in a target base station. The target base station is used in a wireless network. The wireless network comprises at least one mobile station, a host apparatus, and a serving base station. The host apparatus and the at least one mobile station belong to a same handover group and each of them communicates via the serving base station respectively. The communication method comprises the steps of: transmitting uplink information to the host apparatus after the host apparatus and the at least one mobile station of the handover group handover to the target base station, so that the host apparatus processes a handover network entry with optimization procedure with the target base station according to the uplink information; and transmitting a handover completion signal in a multicast way to inform that the host apparatus and the at least one mobile station of the handover group that handovering to the target base station is completed.

According to the above description, the present invention takes the host apparatus as a representative of the mobile stations belonging to the same group to process the handover procedure with the serving base station and the target base station. It can ease the burden of the serving base station, the target base station and the wireless network as a whole during the handover of the mobile stations belonging to the same group. Thereby, shortcomings of the prior art are overcome by the present invention.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a conventional wireless network;

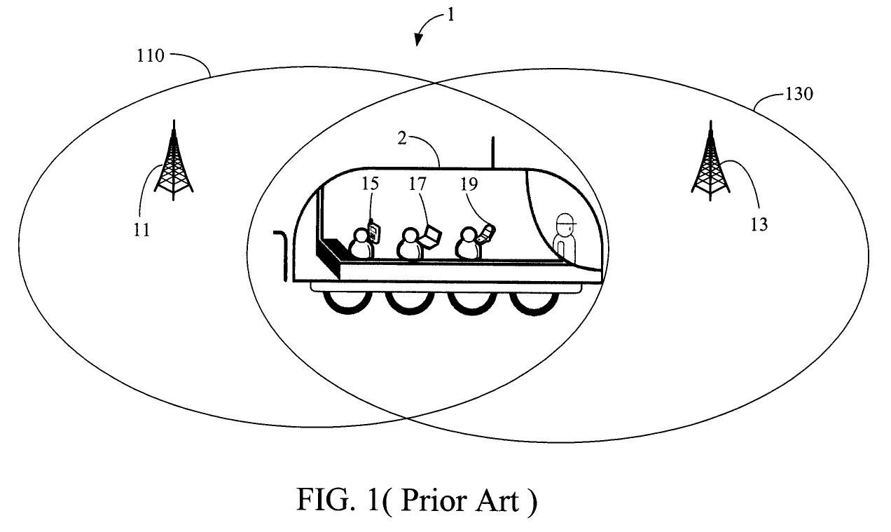

FIG. 2 is a schematic view of a wireless network of the present invention;

FIG. 3 is a schematic view of a wireless network of a first embodiment of the present invention;

FIG. 4 is a schematic view of a mobile station of the first embodiment;

FIG. 5 is a schematic view of a host apparatus of the first embodiment;

FIG. 6 is a schematic view of a serving base station of the first embodiment;

FIG. 7 is a schematic view of a target base station of the first embodiment;

FIG. 8A is a partial flowchart of a second embodiment of the present invention;

FIG. 8B is a partial flowchart of the second embodiment of the present invention;

FIG. 8C is a partial flowchart of the second embodiment of the present invention; and

FIG. 8D is a partial flowchart of the second embodiment of the present invention.

### DESCRIPTION OF THE PREFERRED EMBODIMENT

In the following description, the present invention will be explained with reference to embodiments thereof. Description of the present invention relates to a communication method for use in a wireless network, which is especially adapted for a large number of mobile communication devices moving in the wireless network to the handover areas collectively. However, these embodiments are not intended to limit the present invention to any specific environment, applications or particular implementations described in these embodiments. Therefore, description of these embodiments is only for purpose of illustration rather than to limit the present invention.

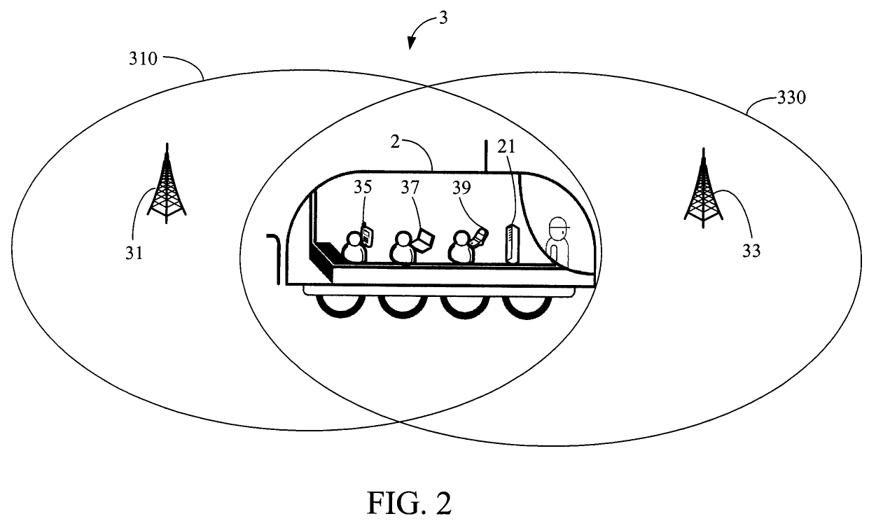

Prior to description of embodiments of the present invention, an environment where the present invention is implemented will be defined at first. Referring to FIG. 2, a schematic view of a wireless network 3 is illustrated therein. The wireless network 3 comprises base stations 31, 33, mobile stations 35, 37, 39 and a host apparatus 21. The base station 31 has a signal coverage 310, and the base station 33 has a signal coverage 330. Users of the mobile stations 35, 37, 39 are on a bus 2. Currently, the bus 2 is traveling from the signal coverage 310 of the base station 31 to the signal coverage 330 of the base station 33, so the signal strength of the base station 31 is fading away while that of the base station 33 is becoming stronger gradually from viewpoints of the mobile stations 35, 37, 39. In order to ensure a certain quality of service, the mobile stations 35, 37, 39 will handover from the base station 31 to the base station 33 via the host apparatus 21. Additionally, as the mobile stations 35, 37, 39 are now being served by the base station 31 for the wireless network services, the base station 31 may be considered as a serving base station. On the other hand, as the mobile stations 35, 37, 39 are going to be handovered to the base station 33, the base station 33 may be considered as a target base station. For purpose of simplicity, interactions between the mobile station 35, the serving base station 31, the target base station 33, and the host apparatus 21 will be illustrated as an example hereinafter; handover functions of the mobile stations 37, 39 are just the same as those of the mobile station 35 and thus will not be further described herein.

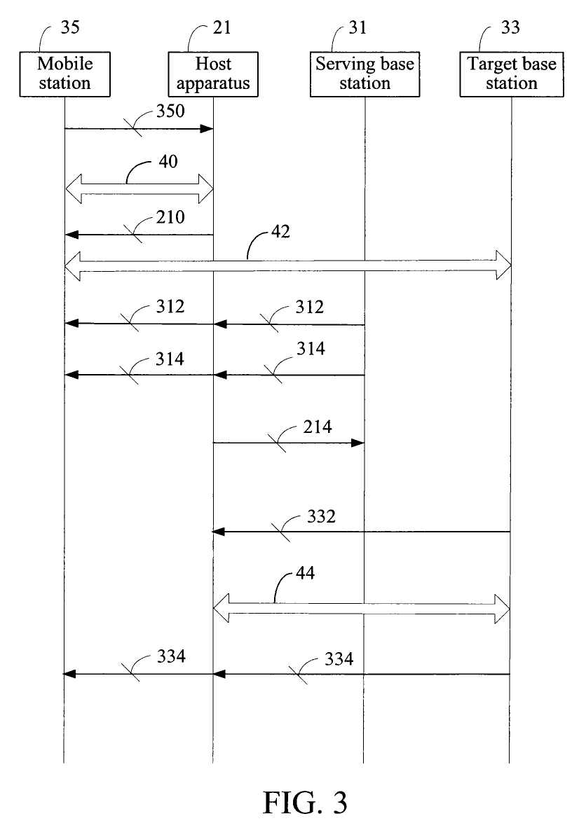

A first embodiment of the present invention is illustrated in FIG. 3, which is a schematic view of a wireless network 3. The wireless network 3 comprises the serving base station 31, the target base station 33, the mobile station 35, and a host apparatus 21. In this embodiment, the wireless network 3 is a WiMAX wireless network implemented in accordance with the IEEE 802.16e standard; however, rather than being limited thereto. The wireless network 3 may also be implemented in accordance with other wireless network standards in other embodiments.

Furthermore, it should be emphasized that, the wireless network 3 is implemented in accordance with the IEEE 802.16e standard, so the serving base station 31 and the target base station 33 are connected to an access services network gateway that provides WiMAX users with wireless access services and transmits authentication, authorization, and session accounting messages to the home network service provider (H-NSP) to which the WiMAX client (i.e., the mobile station 35) belongs, in order to maintain the connection. In other words, in this embodiment, the serving base station 31 and the target base station 33 are two of multiple base stations connected to the access services network gateway, which will be readily appreciated by those of ordinary skill in the art and thus will not be further described herein. For purpose of simplicity, the access services network gateway at the back end of the serving base station 31 and the target base station 33 is not shown in the drawings.

When the user of the mobile station 35 boarding the bus 2, the mobile station 35 transmits a group joining signal 350 to the host apparatus 21 so that the host apparatus 21 will process a handover group joining procedure 40 with the mobile station 35 according to the group joining signal 350 to join the mobile station 35 and the host apparatus 21 to a handover group. In this embodiment, the host apparatus 21 may be a card reader which is installed on the bus. When boarding the bus, the passenger (i.e., the user of the mobile station 35) simply needs to swipe the mobile station 35 via the card reader in order to join in the same handover group as the card reader. It should be noted that, in other embodiments, the host apparatus 21 may also be one of the mobile stations 35, 37, 39. Choosing one of the mobile stations 35, 37, 39 as the host apparatus 21 may be accomplished by a conventional technique, which will not be further described herein.

After the mobile station 35 joins in the handover group, the host apparatus 21 transmits a control signal 210 to the mobile station 35 to disable the handover request function thereof. In other words, after joining to the handover group, the mobile station 35 is switched to a group handover mode and is unable to actively issue a handover request any longer. Next, a multicast group joining procedure 42 is performed between the serving base station 31, the target base station 33, the mobile station 35, the access services network gateway at the back end of the serving base station 31 and the target base station 33, and the host apparatus 21 so that the mobile station 35 and the host apparatus 21 can join to a multicast group of the wireless network 3. More particularly, the multicast group joining procedure is performed between the mobile station 35, the host apparatus 21, and the access services network gateway connected to the serving base station 31 and the target base station 33, so as to register the mobile station 35 with the access services network gateway.

As the bus 2 travels toward the target base station 33, the serving base station 31 actively requests the base station 35 and the host apparatus 21 to handover to the target base station 33, so as to maintain a certain quality of communication for the mobile station 35 and the host apparatus 21. Accordingly, the serving base station 31 firstly enters a handover preparation phase with the target base station 33 and the access services network gateway to reserve resources necessary for the handover. Upon completion of the handover preparation phase, the serving base station 31 actively transmits a group handover request signal 314 in a multicast way. The mobile station 35 and the host apparatus 21 which have joined to the multicast group so they can receive the group handover request signal 314 and learn therefrom that they need to handover to the target base station 33. Also, upon receiving the group handover request signal 314, the mobile station 35 disables the uplink function thereof to avoid interference with the handover process. Additionally, as the wireless network 3 conforms to the IEEE 802.16e standard, the target base station 33 further periodically broadcasts information 312 relating to the target base station 33 so that the mobile station 35 and the host apparatus 21 can be periodically informed of conditions about the target base station 33.

After the mobile station 35 has disabled the uplink function thereof, the host apparatus 21 transmits a handover confirmation signal 214 to the serving base station 31 according to the group handover request signal 314 and the information 312, thereby to inform the serving base station 31 that it can assist in the handover of the mobile station 35 and the host apparatus 21 to the target base station 33. Upon receiving the handover confirmation signal 214, the serving base station 31 enters a handover action phase with the target base station 33 and the access services network gateway to configure the resources reserved in the handover preparation phase.

Upon completion of the handover action phase, the serving base station 31 can assist in the handover of the mobile station 35 and the host apparatus 21 to the target base station 33. It should be noted that, the mobile station 35 and the host apparatus 21 have now handovered to the target base station 33, but the handover procedure has not been fully completed yet. Next, the target base station 33 transmits uplink information 332 to the host apparatus 21 so that the host apparatus 21 will be able to transmit signals to the target base station 33. However, it should be noted that, since the uplink function of the mobile station 35 had been disabled before it handovered to the target base station 33, the mobile station 35 is still unable to transmit any signal to the target base station 33 so far.

After receiving the uplink information 332, the host apparatus 21 processes a handover network entry with optimization procedure 44 with the target base station 33 according to the uplink information 332, so as to leave out unnecessary communication protocols between the host apparatus 21, the mobile station 35, and the target base station 33. The handover network entry with optimization procedure 44 may be accomplished in a conventional way and thus will not be further described herein. Subsequent to the optimization procedure, the target base station 33 transmits a handover completion signal 334 in a multicast way to inform the mobile station 35 and the host apparatus 21 that the handover procedure to the target base station 33 has been completed successfully. After receiving the handover completion signal 334, the mobile station 35 re-enables the uplink function thereof to transmit data to the target base station 33.

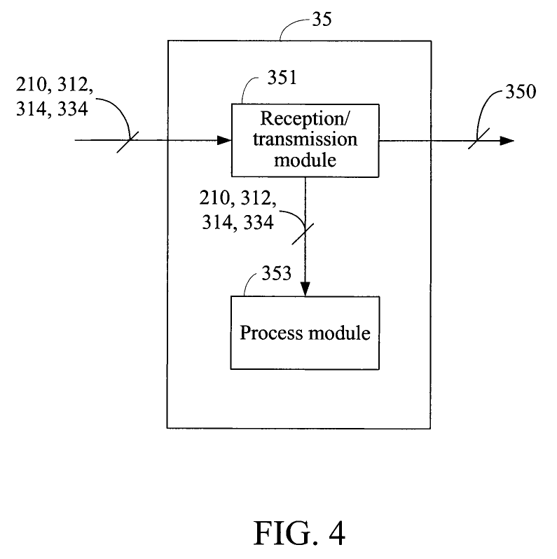

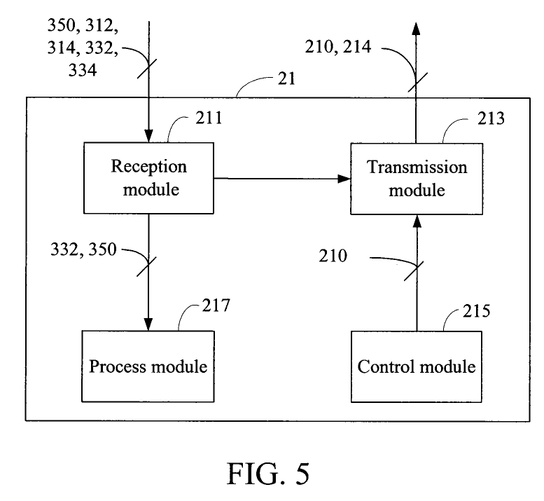

To further illustrate functions of the serving base station 31, the target base station 33, the mobile station 35, and the host apparatus 21 during the handover process, FIG. 4 illustrates a schematic view of the mobile station 35. The mobile station 35 comprises a reception/transmission module 351 and a process module 353. The reception/transmission module 351 of the mobile station 35 is configured to transmit the group joining signal 350 to the host apparatus 21. Referring to FIG. 5 together, a schematic view of the host apparatus 21 is illustrated therein. The host apparatus 21 comprises a reception module 211, a transmission module 213, a control module 215, and a process module 217. After the reception module 211 of the host apparatus 21 receives the group joining signal 350, the process module 217 will join the mobile station 35 and the host apparatus 21 to the handover group according to the group joining signal 350.

As the mobile station 35 and the host apparatus 21 now belong to the same handover group, the control module 215 of the host apparatus 21 transmits a control signal 210 to the mobile station 35 via the transmission module 213 to disable the handover request function of the mobile station 35. When the reception/transmission module 351 of the mobile station 35 receives the control signal 210 from the host apparatus 21, the process module 353 of the mobile station 35 disables the handover request function thereof according to the control signal 210.

Furthermore, after the mobile station 35 and the host apparatus 21 join to the handover group, the process module 217 of the host apparatus 21 registers the mobile station 35 with the access services network gateway by processing the multicast group joining procedure 42 to inform the serving base station 31 and the target base station 33 that the mobile station 35 and the host apparatus 21 have joined to a multicast group of the wireless network 3. Then, the mobile station 35 and the host apparatus 21 can receive signals transmitted by the serving base station 31 and the target base station 33 in a multicast way.

Having the mobile station 35 join to a handover group and registering the mobile station 35 with the access services network gateway may be viewed as preprocesses of the mobile station 35 and the host apparatus 21 prior to the handover. Specifically, the mobile station 35 and the host apparatus 21 are made to join to a handover group, and then the host apparatus 21 is made to operate as a representative of all the mobile stations (for this embodiment, the mobile station 35) in the handover group to transfer control signals. Via the multicast group joining procedure, the mobile station 35 and the host apparatus 21 can be grouped, thereby easing the communication burden of the base stations during the handover process.

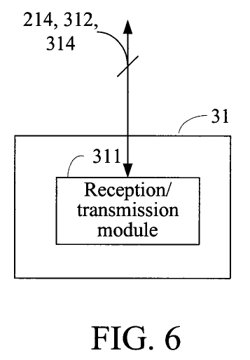

Referring to FIG. 6 together, a schematic view of the serving base station 31 is illustrated therein. The serving base station 31 comprises a reception/transmission module 311. The reception/transmission module 311 is configured to process the multicast group joining procedure 42 with the target base station 33 so that the mobile station 35 is registered with the access services network gateway and the mobile station 35 and the host apparatus 21 can join to the multicast group of the wireless network 3. The reception/transmission module 311 is further configured to periodically transmit the information 312 relating to the target base station 33 in a broadcast way, in order to inform the mobile station 35 and the host apparatus 21 belonging to the wireless network 3 of the information relating to the target base station 33.

Afterwards, the reception/transmission module 311 of the serving base station 31 further transmits a group handover request signal 314 to the mobile station 35 and the host apparatus 21 in a multicast way to request that the mobile station 35 and the host apparatus 21 be prepared for the handover to the target base station 33. The reception/transmission module 351 of the mobile station 35 and the reception module 211 of the host apparatus 21 then receive the group handover request signal 314 and the information 312 transmitted by the serving base station 31, and the process module 353 of the mobile station 35 further disables the uplink function of the mobile station 35 according to the group handover request signal 314.

After the mobile station 35 disables the uplink function thereof, the transmission module 213 of the host apparatus 21 further transmits a handover confirmation signal 214 to the serving base station 31 according to the group handover request signal 314 and the information 312, so as to inform the serving base station 31 that it can assist in the handover of the mobile station 35 and the host apparatus 21 of the handover group to the target base station 33. Upon receiving the handover confirmation signal 214, the reception/transmission module 311 of the serving base station 31 proceeds to assist in the handover of the mobile station 35 and the host apparatus 21 of the handover group to the target base station 33.

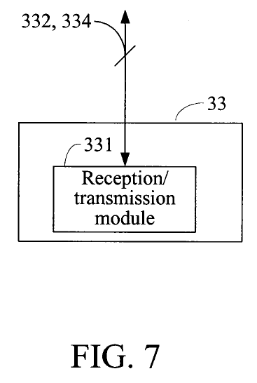

Finally, referring to FIG. 7 together, a schematic view of the target base station 33 is illustrated therein. The target base station 33 comprises a reception/transmission module 331. The reception/transmission module 331 is configured to process the multicast group joining procedure 42 with the serving base station 31 so that the mobile station 35 and the host apparatus 21 can join to the multicast group of the wireless network 3. After the mobile station 35 and the host apparatus 21 of the handover group have handovered to the target base station 33, the reception/transmission module 331 of the target base station 33 is further configured to transmit an uplink information 332 to the host apparatus 21 to inform that the host apparatus 21 can perform a handover network entry with optimization procedure 44 with the target base station 33 according to the uplink information 332. After the reception module 211 of the host apparatus 21 receives the uplink information 332, the process module 217 of the host apparatus 21 processes the handover network entry with optimization procedure 44 with the target base station 33 according to the uplink information 332.

Upon completion of the handover network entry with optimization procedure 44, the reception/transmission module 331 of the target base station 33 transmits a handover completion signal 334 in a multicast way to inform the host apparatus 21 and the mobile station 35 of the handover group that the handover procedure to the target base station 33 has been completed. Once the reception module 211 receives the handover completion signal 334, the host apparatus 21 learns that the handover procedure to the target base station 33 has been completed. Additionally, the reception/transmission module 351 of the mobile station 35 further receives the handover completion signal 334 from the target base station 33 so that the mobile station 35 can learn the handover procedure from the serving base station 31 to the target base station 33 has been completed, and then the process module 353 of the mobile station 353 re-enables the uplink function according to the handover completion signal 334.

According to the above description, by taking the host apparatus 21 as a representative of the mobile stations of the same group to communicate with the serving base station 31 and the target base station 33, the present invention avoids a multiplicity of mobile stations operating in a handover region from communicating with the serving base station 31 and the target base station 33 respectively, thus easing the burden of the serving base station 31, the target base station 33 and the wireless network 3 as a whole. Thereby, shortcomings of the prior art are overcome by the present invention.

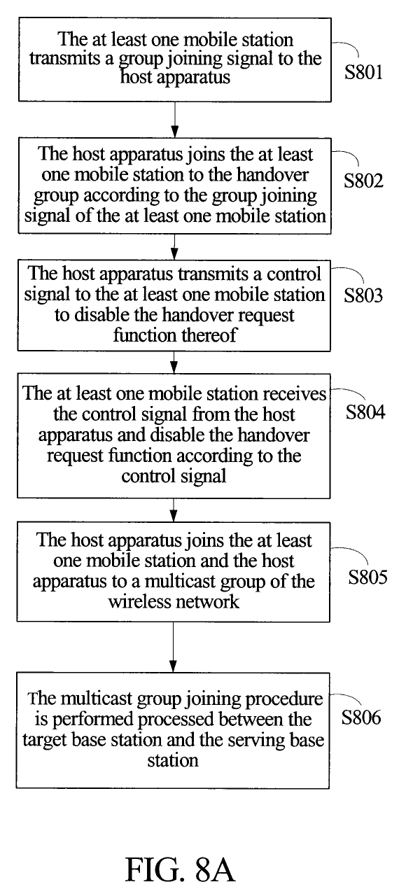

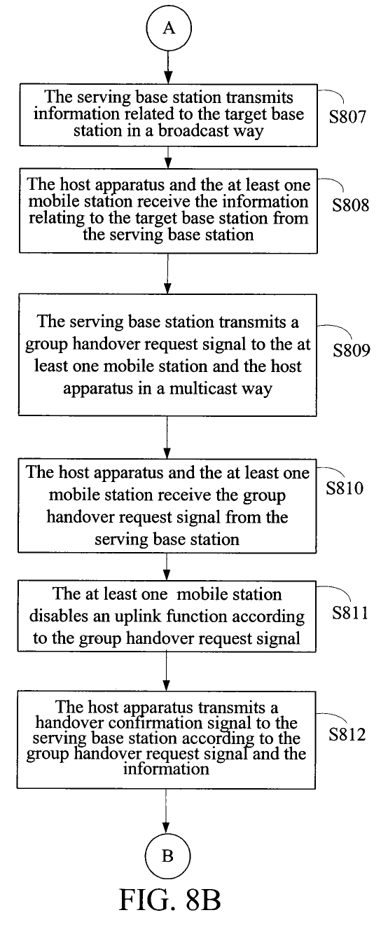

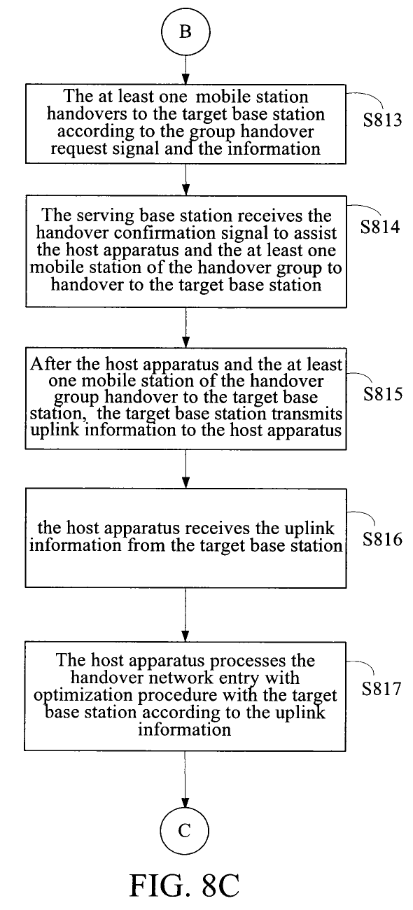

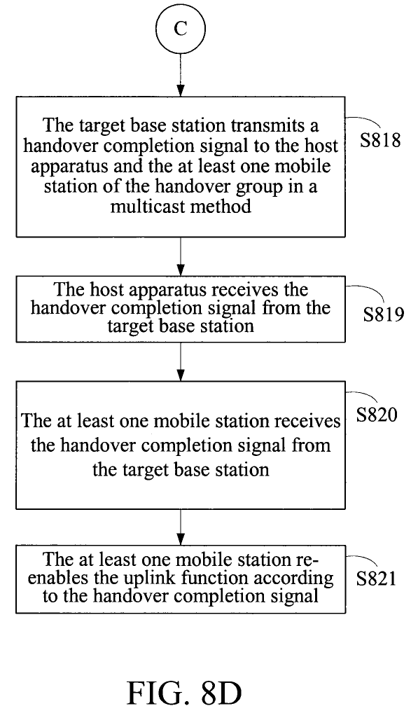

A second embodiment of the present invention is illustrated in FIGS. 8A to 8D, which collectively shows a flowchart of a communication method for the wireless network 3 of the first embodiment. Referring to FIG. 8A, initially in step S801, the at least one mobile station transmits a group joining signal to the host apparatus so that the host apparatus will join the mobile station and the host apparatus to the same handover group according to the group joining signal.

Next in step S802, the host apparatus joins the at least one mobile station to the handover group according to a group joining signal of the at least one mobile station. Then in step S803, the host apparatus transmits a control signal to the at least one mobile station to disable the handover request function of the at least one mobile station. Afterwards, in step S804, the mobile station receives a control signal from the host apparatus and disables the handover request function according to the control signal.

Next, in step S805, upon the at least one mobile station joining to the handover group, the host apparatus joins the at least one mobile station and the host apparatus to a multicast group of the wireless network via a multicast group joining procedure. In step S806, the multicast group joining procedure is processed between the target base station, the serving base station, the mobile station, the access services network gateway at the back end of the serving base station and the target base station, and the host apparatus, so that the at least one mobile station and the host apparatus can join to the multicast group of the wireless network and the mobile station is registered with the access services network gateway.

Referring to FIG. 8B, in step S807, the serving base station transmits information relating to the target base station in a broadcast way, and in step S808, the host apparatus and the mobile station receive the information, relating to the target base station, from the serving base station. In step S809, the serving base station transmits a group handover request signal to the at least one mobile station and the host apparatus in a multicast way to request that the at least one mobile station and the host apparatus handover to the target base station. In step S810, the host apparatus and the at least one mobile station receive the group handover request signal transmitted by the serving base station in a multicast way. Subsequently in step S811, the at least one mobile station disables an uplink function thereof according to the group handover request signal, and in step S812, the host apparatus transmits a handover confirmation signal to the serving base station according to the group handover request signal and the information so that the at least one mobile station and the host apparatus of the handover group can handover to the target base station.

Referring next to FIG. 8C, in step S813, the at least one mobile station handovers to the target base station according to the group handover request signal and the information. In step S814, the serving base station receives the handover confirmation signal to assist the host apparatus and the at least one mobile station of the handover group to handover to the target base station. In step S815, after the host apparatus and the at least one mobile station of the handover group handover to the target base station, the target base station transmits uplink information to the host apparatus so that the host apparatus can process a handover network entry with optimization procedure with the target base station according to the uplink information.

In step S816, after the at least one mobile station and the host apparatus of the handover group handover to the target base station, the host apparatus receives the uplink information from the target base station and processes the handover network entry with optimization procedure with the target base station according to the uplink information in step S817. Referring to FIG. 8D, in step S818, the target base station transmits a handover completion signal in a multicast way to inform the host apparatus and the at least one mobile station of the handover group that handovering to the target base station is completed. Next, in step S819, the host apparatus receives the handover completion signal from the target base station, and the at least one mobile station receives the handover completion signal from the target base station in step S820 so that the at least one mobile station learns that it has handovered to the target base station. Finally in step S821, the at least one mobile station re-enables the uplink function according to the handover completion signal.

In addition to the aforesaid steps, the second embodiment can also execute all the functions and operations set forth in the first embodiment, which will be readily appreciated by those skilled in the art based on the explanation of the first embodiment and thus will not be further described herein.

According to the above description, by having the host apparatus and the mobile stations operate as a group, switching the mobile stations to a group handover mode, and having the host apparatus operate as a representative of the mobile stations of the same group to process the handover procedure with the serving base station, the target base station, and the access services network gateway, the present invention eases the burden of the serving base station, the target base station, and the wireless network as well as waste of the bandwidth during handover of mobile stations of the same group. Thereby, the present invention can overcome the shortcomings of the prior art.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A communication method for use in a host apparatus, the host apparatus being adapted to a wireless network, the wireless network comprising at least one mobile station, a serving base station, and a target base station, the at least one mobile station and the host apparatus belonging to a same handover group and each of the at least one mobile station and the host apparatus communicating via the serving base station respectively, the communication method comprising the steps of:
receiving information, relating to the target base station, from the serving base station;
receiving a group handover request signal, transmitted in a multicast way, from the serving base station; and
transmitting a handover confirmation signal to the serving base station according to the group handover request signal and the information so that the at least one mobile station and the host apparatus of the handover group may handover to the target base station.

2. The communication method of claim 1, further comprising the step of:
transmitting a control signal to the at least one mobile station to disable a handover request function of the at least one mobile station.

3. The communication method of claim 1, further comprising the steps of:
receiving uplink information from the target base station after the at least one mobile station and the host apparatus of the handover group handover to the target base station;
processing a handover network entry with optimization procedure with the target base station according to the uplink information; and
receiving a handover completion signal from the target base station, so as to be aware of that handovering to the target base station is completed.

4. The communication method of claim 1, further comprising the steps of:
joining the at least one mobile station to the handover group according to a group joining signal of the at least one mobile station; and
joining the at least one mobile station and the host apparatus to a multicast group of the wireless network via a multicast group joining procedure according to the at least one mobile station joining in the handover group.

5. A host apparatus for use in a wireless network, the wireless network comprising at least one mobile station, a serving base station, and a target base station, the at least one mobile station and the host apparatus belonging to a same handover group, each of the at least one mobile station and the host apparatus communicating via the serving base station respectively, the host apparatus comprising:
a reception module, being configured to receive information, relating to the target base station, from the serving base station, and a group handover request signal, transmitted in a multicast way, from the serving base station; and
a transmission module, being configured to transmit a handover confirmation signal to the serving base station according to the group handover request signal and the information so that the at least one mobile station and the host apparatus of the handover group may handover to the target base station.

6. The host apparatus of claim 5, further comprising a control module being configured to transmit a control signal to the at least one mobile station, via the transmission module, to disable a handover request function of the at least one mobile station.

7. The host apparatus of claim 5, further comprising:
a process module;
wherein the reception module is further configured to receive uplink information from the target base station after the at least one mobile station and the host apparatus of the handover group handover to the target base station, the process module is configured to process a handover network entry with optimization procedure with the target base station according to the uplink information, and the reception module is further configured to receive a handover completion signal from the target base station to be aware of that handovering to the target base station is completed.

8. The host apparatus of claim 5, wherein the process module is further configured to join the at least one mobile station to the handover group according to a group joining signal of the at least one mobile station, and join the at least one mobile station and the host apparatus to a multicast group of the wireless network via a multicast group joining procedure according to the at least one mobile station joining in the handover group.

9. A communication method for use in a mobile station, the mobile station being used in a wireless network, the wireless network comprising a host apparatus, a serving base station, and a target base station, each of the host apparatus and the mobile station communicating via the serving base station respectively, the communication method comprising the steps of:
transmitting a group joining signal to the host apparatus so that the host apparatus joins the mobile station and the host apparatus to a handover group according to the group joining signal;
receiving information, relating to the target base station, from the serving base station;
receiving a group handover request signal, transmitted in a multicast way, from the serving base station; and
handovering to the target base station according to the group handover request signal and the information.

10. The communication method of claim 9, further comprising the steps of:
receiving a control signal from the host apparatus; and
disabling a handover request function according to the control signal.

11. The communication method of claim 9, further comprising the step of:
disabling an uplink function according to the group handover request signal.

12. The communication method of claim 9, further comprising the steps of:
receiving a handover completion signal from the target base station, so as to be aware of that the mobile station handovers to the target base station; and
re-enabling the uplink function according to the handover completion signal.

13. A mobile station for use in a wireless network, the wireless network comprising a host apparatus, a serving base station, and a target base station, each of the host apparatus and the mobile station communicating via the serving base station respectively, the mobile station comprising:
a reception/transmission module, being configured to transmit a group joining signal to the host apparatus so that the host apparatus joins the mobile station and the host apparatus to a handover group according to the group joining signal, receive information, relating to the target base station, from the serving base station, and receive a group handover request signal, transmitted in a multicast way, from the serving base station; and
a process module, being configured to handover to the target base station according to the group handover request signal and the information.

14. The mobile station of claim 13, wherein the reception/transmission module is further configured to receive a control signal from the host apparatus, and the process module is further configured to disable a handover request function according to the control signal.

15. The mobile station of claim 13, wherein the process module is further configured to disable an uplink function according to the group handover request signal.

16. The mobile station of claim 15, wherein the reception/transmission module is further configured to receive a handover completion signal from the target base station to be aware of that the mobile station handovers to the target base station, and the process module is further configured to re-enable the uplink function according to receive the handover completion signal.

17. A communication method for use in a serving base station, the serving base station being used in a wireless network, the wireless network comprising at least one mobile station, a host apparatus, and a target base station, the host apparatus and the at least one mobile station belonging to a same handover group, each of the host apparatus and the at least one mobile station communicating via the serving base station respectively, the communication method comprising the steps of:
transmitting information, relating to the target base station, in a broadcast way;
transmitting a group handover request signal to the at least one mobile station and the host apparatus in a multicast way, so as to request the at least one mobile station and the host apparatus to handover to the base station and make the host apparatus transmit a handover confirmation signal according to the information and the group handover request signal; and
receiving the handover confirmation signal to handover the host apparatus and the at least one mobile station of the handover group to the target base station.

18. The communication method of claim 17, further comprising the step of:
processing a multicast group joining procedure with the target base station so that the at least one mobile station and the host apparatus join to a multicast group of the wireless network.

19. A serving base station for use in a wireless network, the wireless network comprising at least one mobile station, a host apparatus, and a target base station, the host apparatus and the at least one mobile station belonging to a same handover group, each of the host apparatus and the at least one mobile station communicating via the serving base station respectively, the serving base station comprising:
a reception/transmission module, being configured to transmit information, relating to the target base station, in a broadcast way, transmit a group handover request signal to the at least one mobile station and the host apparatus in a multicast way, so as to request the at least one mobile station and the host apparatus to handover to the base station and make the host apparatus transmit a handover confirmation signal according to the information and the group handover request signal, the reception/transmission module being further configured to receive the handover confirmation signal to handover the host apparatus and the at least one mobile station of the handover group to the target base station according to the transmission of the handover confirmation signal.

20. The serving base station of claim 19, wherein the reception/transmission module is further configured to process a multicast group joining procedure with the target base station so that the at least one mobile station and the host apparatus join to a multicast group of the wireless network.

21. A communication method for use in a target base station, the target base station being used in a wireless network, the wireless network comprising at least one mobile station, a host apparatus, and a serving base station, the host apparatus and the at least one mobile station belonging to a same handover group, each of the host apparatus and the at least one mobile station communicating via the serving base station respectively, the communication method comprising the steps of:
transmitting uplink information to the host apparatus after the host apparatus and the at least one mobile station of the handover group handover to the target base station, so that the host apparatus processes a handover network entry with optimization procedure with the target base station according to the uplink information; and
transmitting a handover completion signal in a multicast way to inform the host apparatus and the at least one mobile station of the handover group that the handovering to the target base station is completed.

22. The communication method of claim 21, further comprising the step of processing a multicast group joining procedure with the serving base station so that the at least one mobile station and the host apparatus join to a multicast group of the wireless network.

23. A target base station for use in a wireless network, the wireless network comprising at least one mobile station, a host apparatus, and a serving base station, the host apparatus and the at least one mobile station belonging to a same handover group, each of the host apparatus and the at least one mobile station communicating via the serving base station respectively, the target base station comprising:
a reception/transmission module, being configured to transmit uplink information to the host apparatus after the host apparatus and the at least one mobile station of the handover group handover to the target base station, so that the host apparatus processes a handover network entry with optimization procedure with the target base station according to the uplink information, and being further configured to transmit a handover completion signal in a multicast way to inform the host apparatus and the at least one mobile station of the handover group that the handovering to the target base station is completed.

24. The target base station of claim 23, wherein the reception/transmission module is further configured to process a multicast group joining procedure with the serving base station so that the at least one mobile station and the host apparatus join to a multicast group of the wireless network.
